(19) United States
(12) Patent Application Publication
(10) Pub. No.: US 2005/0001364 A1
(43) Pub. Date: Jan. 6, 2005

(54) Hydraulic antivibration support

(76) Inventors: Herve Visage, Chateaudun (FR); Julien Lecordier, Chateaudun (FR); Michael Ligouy, Lugny-Champagne (FR)

Correspondence Address: MCCRACKEN & FRANK LLP, 200 W. ADAMS STREET, SUITE 2150, CHICAGO, IL, 60606, US

(21) Appl. No.: 10/871,625

(22) Filed: Jun. 18, 2004

(30) Foreign Application Priority Data
Jun. 20, 2003 (FR) 03 07476

(51) Int. Cl. F16M 3/00

(52) U.S. Cl. 267/140.4

(57) ABSTRACT

A hydraulic antivibration support comprising first and second rigid strength members interconnected by an elastomer body which defines part of a hydraulic working chamber, a flexible wall which defines part of a hydraulic compensation chamber connected to the working chamber via a constricted passage, a rigid partition secured to the second strength member, and annular reinforcement fixed directly to the periphery of the flexible wall and engaged in the second strength member. The constricted passage extends within the annular reinforcement of the flexible wall.

### FIELD OF THE INVENTION

The present invention relates to hydraulic antivibration supports.

More precisely, the invention relates to a hydraulic antivibration support for interposing between two rigid elements and comprising:
first and second rigid strength members for fixing to the two rigid elements that are to be united;
an elastomer body interconnecting the first and second strength members and defining part of a working chamber filled with liquid;
a flexible wall defining part of a compensation chamber filled with liquid and connected to the working chamber via a constricted passage;
a rigid partition secured to the second strength member and separating the working chamber from the compensation chamber, the rigid partition presenting an outer periphery that is flat; and
rigid annular reinforcement fixed directly to the periphery of the flexible wall and engaged in the second strength member, the annular reinforcement being clamped axially against the flat outer periphery of the rigid partition, said outer periphery presenting thickness that is less than the thickness of the annular reinforcement.

### BACKGROUND OF THE INVENTION

Document EP-A-0 980 990 describes an example of such an antivibration support, which presents in particular the drawback of being relatively large in the vertical direction and of not guaranteeing accurate positioning where the annular reinforcement and the elastomer of the flexible wall bear against the rigid partition.

### OBJECTS AND SUMMARY OF THE INVENTION

A particular object of the present invention is to mitigate those drawbacks.

To this end, according to the invention, in an antivibration support of the kind in question, the annular reinforcement includes a peripheral groove that is covered by the rigid partition and that co-operates with the rigid partition to define the constricted passage, and the annular reinforcement is disposed entirely in register with the flat outer periphery of the rigid partition and bears against said flat outer periphery on either side of the groove.

In various embodiments of the invention, recourse may optionally be had to one or more of the following dispositions:
the flexible wall is overmolded on the annular reinforcement;
the flexible wall is bonded on the annular reinforcement;
the flexible wall is snap-fastened on the annular reinforcement;
the annular reinforcement is clamped against the rigid partition;
an annular portion of the flexible wall is interposed between the annular reinforcement and the rigid partition;
the annular reinforcement is fixed to the second strength member at least by crimping, the crimping also clamping said annular reinforcement against the rigid partition;
the constricted passage communicates with the working chamber via an opening formed through the rigid partition;
a portion of the flexible wall lines the inside of the peripheral groove of the annular reinforcement: this disposition makes it possible, where appropriate, to form constricted passages of various sections using the same annular reinforcement, and thus to obtain different resonant frequencies for the constricted passage; it is thus possible to use the same annular reinforcement in different antivibration supports presenting different antivibration characteristics, thereby providing savings due to standardization of the annular reinforcement; and
the rigid partition comprises two superposed metal sheets presenting respective bulging central portions forming grids and defining between them a central housing containing a flexible valve member adapted to vibrate with limited clearance between the two grids, which grids communicate respectively with the working chamber and with the compensation chamber, the two superposed metal sheets also forming said flat outer periphery of the rigid partition around said bulging central portions.

### BRIEF DESCRIPTION OF THE DRAWING

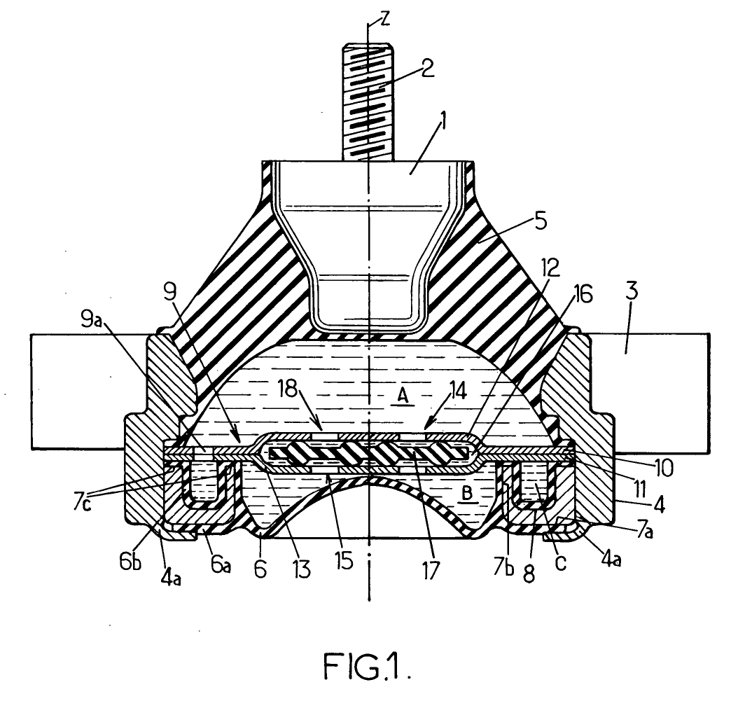

Other characteristics and advantages of the invention appear from the following description of an embodiment, given by way of non-limiting example, and with reference to the accompanying drawing. In the drawing, FIG. 1 is a vertical section view through a hydraulic antivibration surface constituting an embodiment of the invention.

### MORE DETAILED DESCRIPTION

FIG. 1 shows a hydraulic antivibration support comprising a first rigid strength member 1 in the form of a metal head secured to an upwardly-directed pin 2 lying on a central axis Z and designed to be fixed to the engine of a vehicle, for example.

The antivibration support also comprises a second rigid strength member 3 which is designed to be fixed to the body of the vehicle, for example, and which comprises in particular a metal ring 4.

The first and second strength members are connected to each other by an elastomer body 5 capable of withstanding in particular the static forces due to the weight of the engine. The elastomer body may present a bell-shape, for example, extending between a top that is overmolded and bonded to the head and an annular base that is overmolded and bonded on the ring 4.

The antivibration support also comprises a flexible wall 6 that is easily deformable, generally being made of elastomer. This flexible wall is bonded directly to rigid annular reinforcement 7 which may be made of metal or possibly out of plastics material and which is engaged in leaktight manner inside the ring 4 of the second strength member, so that the elastomer body 5, the second strength member 3, and the flexible wall 6 together define a closed housing that is filled with liquid.

The annular reinforcement 7 has a peripheral inside groove 8 occupying at least 360° and opens parallel to the axis Z looking towards the elastomer body 5.

In the example shown in FIG. 1, the flexible wall 6 includes a diaphragm 6a made out of the same material as the remainder of the flexible wall, lining the bottom face 7a of the annular reinforcement 7, i.e. the face of the reinforcement which faces away from the elastomer body 5, while another diaphragm 6b, made out of the same material as the remainder of the flexible wall 6, lines the radially inner face 7b of the annular reinforcement 7 and also the top face 7c of said reinforcement (i.e. the face of said reinforcement that faces axially towards the elastomer body 5), and the inside surface of the groove 8.

Advantageously, the flexible wall 6 is overmolded and bonded onto the rigid reinforcement 7, but where appropriate, the flexible wall could merely be overmolded without bonding, or indeed said flexible wall could be molded independently of the annular reinforcement 7 and could then be engaged on said annular reinforcement, thus becoming fixed thereto by snap-fastening.

Furthermore, a rigid partition 9, e.g. made of metal or where appropriate out of plastic material, is interposed between the annular reinforcement 7 and the base of the elastomer body. Advantageously, the annular reinforcement 7 is clamped axially against the rigid partition 9, with the diaphragm 6b integrally formed with the flexible wall 7 being interposed between them. This axial clamping can be obtained, for example, by crimping implemented between the ring 4 and the annular reinforcement 7. For example, the ring 4 may include tabs 4a that are folded under the annular reinforcement 7 to provide said crimping.

The rigid partition 9 subdivides the inside of the antivibration support into a working chamber A defined in part by the elastomer body 5, and a compensation chamber B defined in part by the flexible wall 6. These two chambers A and B are filled with liquid and they communicate with each other via a constricted passage C which is likewise filled with liquid, which passage is defined between the groove 8 in the annular reinforcement and the rigid partition 9. This constricted passage C communicates with the working chamber A via an opening 9a made through the rigid partition, and it communicates with the compensation chamber B via an additional opening (not shown) which is formed radially towards the inside through the annular reinforcement 7.

The constricted passage C allows liquid to be transferred between the working chamber A and the compensation chamber B, thus making it possible in particular to damp vibratory movements of relatively large amplitude (e.g. greater than 1 millimeter (mm)) and of relatively low frequency (e.g. less than 20 hertz (Hz)) between the engine and the body of the vehicle, in particular “choppy” movements due to the vehicle running over irregular ground.

Advantageously, the rigid partition 9 presents a outer periphery that is flat and perpendicular to the central axis Z in the vicinity of the annular reinforcement 7. This outer periphery is of a thickness that is considerably less than that of the annular reinforcement 7, parallel to the central axis Z.

In particular, the rigid partition 9 may be constituted by one or two sheets of metal, and said outer periphery of the rigid partition then presents thickness restricted to the thickness of the metal sheet(s) constituting the rigid partition.

In the example shown in FIG. 1, the rigid partition 9 is constituted by two superposed sheets 10, 11 which may be symmetrical to each other.

Advantageously, these two sheets 10, 11 may present bulging central portions 12, 13 forming respective grids 14, 15. The grids 14, 15 communicate respectively with the working chamber A and with the compensation chamber B, and between them they define a valve housing 16 containing a valve member 17.

By way of example, the valve member 17 is constituted by a flexible diaphragm of elastomer adapted to vibrate with limited clearance (e.g. less than about 0.5 mm) between the two grids 14, 15. The valve member 17 thus co-operates with the grids 14, 15 to define a decoupling valve 18 adapted to absorb vibration of low amplitude (e.g. less than 1 mm) and of relatively high frequency (e.g. higher than 20 Hz) as applied by the engine to the first strength member 1.

It should be observed that because the flexible wall 6 of elastomer lines the inside of the groove 8, it is possible to obtain a desired flow section for the constricted passage C by acting on the thickness of the elastomer diaphragm 6b. Thus, the same annular reinforcement 7 can be used in a plurality of different antivibration supports, having different desired flow sections for the constricted passage C. The flow section in question determines the resonant frequency of the constricted passage C, thus making it possible to determine the damping characteristics of the antivibration support at relatively low frequency (e.g. lower than 20 Hz).

1. A hydraulic antivibration support for interposing between two rigid elements and comprising:
first and second rigid strength members for fixing to the two rigid elements that are to be united;
an elastomer body interconnecting the first and second strength members and defining part of a working chamber filled with liquid;
a flexible wall defining part of a compensation chamber filled with liquid and connected to the working chamber via a constricted passage;
a rigid partition secured to the second strength member and separating the working chamber from the compensation chamber, the rigid partition presenting an outer periphery that is flat; and
rigid annular reinforcement fixed directly to the periphery of the flexible wall and engaged in the second strength member, the annular reinforcement being clamped axially against the flat outer periphery of the rigid partition, said outer periphery presenting thickness that is less than the thickness of the annular reinforcement;
wherein the annular reinforcement includes a peripheral groove that is covered by the rigid partition and that co-operates with the rigid partition to define the constricted passage, and wherein the annular reinforcement is disposed entirely in register with the flat outer periphery of the rigid partition and bears against said flat outer periphery on either side of the groove.

2. An antivibration support according to claim 1, in which the flexible wall is overmolded on the annular reinforcement.

3. An antivibration support according to claim 1, in which the flexible wall is bonded on the annular reinforcement.

4. An antivibration support according to claim 1, in which the flexible wall is snap-fastened on the annular reinforcement.

5. An antivibration support according to claim 1, in which the annular reinforcement is clamped against the rigid partition.

6. An antivibration support according to claim 5, in which an annular portion of the flexible wall is interposed between the annular reinforcement and the rigid partition.

7. An antivibration support according to claim 5, in which the annular reinforcement is fixed to the second strength member at least by crimping, the crimping also clamping said annular reinforcement against the rigid partition.

8. An antivibration support according to claim 1, in which the constricted passage communicates with the working chamber via an opening formed through the rigid partition.

9. An antivibration support according to claim 1, in which a portion of the flexible wall lines the inside of the peripheral groove of the annular reinforcement.

10. An antivibration support according to claim 1, in which the rigid partition comprises two superposed metal sheets presenting respective bulging central portions forming grids and defining between them a central housing containing a flexible valve member adapted to vibrate with limited clearance between the two grids, which grids communicate respectively with the working chamber and with the compensation chamber, the two superposed metal sheets also forming said flat outer periphery of the rigid partition around said bulging central portions.
